(19) United States
(12) Patent Application Publication
(10) Pub. No.: US 2024/0064073 A1
(43) Pub. Date: Feb. 22, 2024

(54) REDUCING LATENCY IN A COMMUNICATION NETWORK BETWEEN A SENDER AND A RECEIVER

(71) Applicant: Nokia Technologies Oy, Espoo (FI)

(72) Inventors: Kimmo Kalervo HÄTÖNEN, Espoo (FI); Sasu TARKOMA, Helsinki (FI)

(21) Appl. No.: 18/259,865

(22) PCT Filed: Dec. 31, 2020
(86) PCT No.: PCT/EP2020/088066

§ 371 Date: Jun. 29, 2023

(51) Int. Cl. H04L 43/028; H04L 41/147

(52) U.S. Cl. CPC H04L 43/028; H04L 41/147

(57) ABSTRACT

Various example embodiments provide a solution for reducing latency between a sending entity and a receiving entity. This may be enabled by arranging a receiver model at a sending entity, the receiving model being used by the sending entity to predict receiver behavior, and a sender model at the receiving entity, the sender model being used to predict the sending entity behavior. As the receiving model and the sending model are synchronized with each other and the entities are able to predict each other's behavior, latency between the sending entity to the receiving entity and the amount of information transmitted from the sending entity to the receiving entity may be reduced. Apparatuses, methods, and computer programs are disclosed.

### TECHNICAL FIELD

Various example embodiments generally relate to the field of data communications. In particular, some example embodiments relate to reducing latency in communication networks.

### BACKGROUND

When elements in a same communication network or residing in different communication networks communicate with each other, latency and reaction time have a significant effect on the overall functioning of data communications and systems. The reaction time is basically a time that it takes for a first network entity to identify some event. Then, if a notification relating to the event is to be sent to a second network entity, latency is the time that it takes for the notification to travel from the first network entity to the second network entity. Depending on the communication networks, the latency may be, for example, milliseconds or even several seconds. If latency is high, it may significantly reduce the ability of various network elements to react to various events.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide an efficient solution for reducing latency in communication networks. This may be provided by anticipating events at a sender instead of the sender sending a notification about the event. This benefit may be achieved by the features of the independent claims. Further implementation forms are provided in the dependent claims, the description, and the drawings.

According to an aspect, an apparatus may comprise at least one processor and at least one memory including computer program code, the at least one memory and the computer code configured to, with the at least one processor, cause the apparatus at least to: apply, by a sender module, a receiver model associated with a data source, the receiver model being configured to predict the behavior of a receiver module, the receiver model being synchronized with a sender model applied by the receiver module, the sender model being configured to predict the behavior of the sender module at the receiver module; and omit, by the sender module, based on the receiver model, messages associated with events that will be generated by the receiver module applying the sender model

According to an example embodiment, the at least one memory and the computer code may be further configured to, with the at least one processor, cause the apparatus to: determine, by the sender module, a first message to be sent to the receiver module, the message being associated with an event not predicted by the sender model applied by the receiver module; and cause, by the sender module, transmission of the first message to the receiver module.

According to an example embodiment, the at least one memory and the computer code may be further configured to, with the at least one processor, cause the apparatus to: determine, by the sender module, a second message to be sent to the receiver module when the receiver module is expected to provide a false positive prediction based on the sender model applied by the receiver module; and cause, by the sender module, transmission of the second message to the receiver module.

According to an example embodiment, the at least one memory and the computer code may be further configured to, with the at least one processor, cause the apparatus to: fail, by the sender module, to detect an event predicted by the receiver model applied by the sender module within a safety period; and cause, by the sender module, transmission of the second message to the receiver module after expiry of the safety period.

According to an example embodiment, the at least one memory and the computer code may be further configured to, with the at least one processor, cause the apparatus to: detect, by the sender module, an event predicted by the receiver model applied by the sender module; and return, by the sender module, to a monitoring state.

According to an example embodiment, the at least one memory and the computer code may be further configured to, with the at least one processor, cause the apparatus to: store, by the sender module, information associated with generating the receiver model; receive, by the sender module, parameter data associated with generating the receiver model; and generate, by the sender module, the receiver model based on the stored information and the parameter data.

According to an example embodiment, the at least one memory and the computer code may be further configured to, with the at least one processor, cause the apparatus to: receive the receiver model from an external entity.

According to another aspect, an apparatus may comprise at least one processor and at least one memory including computer program code, the at least one memory and the computer code configured to, with the at least one processor, cause the apparatus at least to: apply, by a receiver module, a sender model associated with a data source, the sender model being configured to predict the behavior of a sender module, the sender model being synchronized with a receiver model applied by the sender module, the receiver model being configured to predict the behavior of the receiver module at the sender module; generate, by the receiver module, an event based on the sender model applied by the receiver module; and cause, by the receiver module, transmission of the event.

According to an example embodiment, the at least one memory and the computer code may be further configured to, with the at least one processor, cause the apparatus to: receive, by the receiver module, a first message, the first message being associated with an event not predicted by the sender model applied by the receiver module; and cause, by the receiver module, transmission of an event based on the first message.

According to an example embodiment, the at least one memory and the computer code may be further configured to, with the at least one processor, cause the apparatus to: receive, by the receiver module, a second message indicating that the sender model applied by the receiver module is expected to provide a false positive prediction; and prevent, by the receiver module, transmission of an event based on the second message.

According to an example embodiment, the at least one memory and the computer code may be further configured to, with the at least one processor, cause the apparatus to: fail, by the receiver module, to receive within a safety period a second message indicating that the receiver is expected to provide a false positive prediction based on the sender model; and cause, by the receiver module, transmission of the event.

According to an example embodiment, the at least one memory and the computer code may be further configured to, with the at least one processor, cause the apparatus to: store, by the receiver module, information associated with generating the sender model; receive, by the receiver module, parameter data associated with generating the sender model; and generate, by the receiver module, the sender model based on the stored information and the parameter data.

According to an example embodiment, the at least one memory and the computer code may be further configured to, with the at least one processor, cause the apparatus to: receive the sender module from an external entity.

According to another aspect, a method may comprise: applying, by a sender module, a receiver model associated with a data source, the receiver model being configured to predict the behavior of a receiver module, the receiver model being synchronized with a sender model applied by the receiver module, the sender model being configured to predict the behavior of the sender module; and omitting, by the sender module, based on the receiver model, messages associated with events that will be generated by the receiver module applying the sender model.

According to an example embodiment, the method further comprises determining, by the sender module, a first message to be sent to the receiver module, the message being associated with an event not predicted by the sender model applied by the receiver module; and causing, by the sender module, transmission of the first message to the receiver module.

According to an example embodiment, the method further comprises determining, by the sender module, a second message to be sent to the receiver module when the receiver module is expected to provide a false positive prediction based on the sender model applied by the receiver module; and causing, by the sender module, transmission of the second message to the receiver module.

According to an example embodiment, the method further comprises failing, by the sender module, to detect an event predicted by the receiver model applied by the sender module within a safety period; and causing, by the sender module, transmission of the second message to the receiver module after expiry of the safety period.

According to an example embodiment, the method further comprises detecting, by the sender module, an event predicted by the receiver model applied by the sender module; and returning, by the sender module, to a monitoring state.

According to an example embodiment, the method further comprises storing, by the sender module, information associated with generating the receiver model; receiving, by the sender module, parameter data associated with generating the receiver model; and generating, by the sender module, the receiver model based on the stored information and the parameter data.

According to an example embodiment, the method further comprises receiving the receiver model from an external entity.

According to another aspect, a method may comprise: applying, by a receiver module, a sender model associated with a data source, the sender model being configured to predict the behavior of a sender module, the sender model being synchronized with a receiver model applied by the sender module, the receiver model being configured to predict the behavior of the receiver module at the sender module; generating, by the receiver module, an event based on the sender model applied by the receiver module; and causing, by the receiver module, transmission of the event.

According to an example embodiment, the method further comprises receiving, by the receiver module, a first message, the first message being associated with an event not predicted by the sender model applied by the receiver module; and causing, by the receiver module, transmission of an event based on the first message.

According to an example embodiment, the method further comprises receiving, by the receiver module, a second message indicating that the sender model applied by the receiver module is expected to provide a false positive prediction; and preventing, by the receiver module, transmission of an event based on the second message.

According to an example embodiment, the method further comprises failing, by the receiver module, to receive within a safety period a second message indicating that the receiver is expected to provide a false positive prediction based on the sender model; and causing, by the receiver module, transmission of the event.

According to an example embodiment, the method further comprises storing, by the receiver module, information associated with generating the sender model; receiving, by the receiver module, parameter data associated with generating the sender model; and generating, by the receiver module, the sender model based on the stored information and the parameter data.

According to an example embodiment, the method further comprises receiving the sender module from an external entity.

According to another aspect, a method may comprise: creating, based on statistical data, a model for a data source; analyzing networking environment associated with the data source to set at least one key parameter associated with the data source; generating a sender module and a receiver module based on the model and the at least one key parameter; and causing transmission of the sender module and the receiver module.

According to another aspect, a computer program may comprise instructions for causing an apparatus to perform at least the following: applying, by a sender module, a receiver model associated with a data source, the receiver model being configured to predict the behavior of a receiver module, the receiver model being synchronized with a sender model applied by the receiver module, the sender model being configured to predict the behavior of the sender module; and omitting, by the sender module, based on the receiver model, messages associated with events that will be generated by the receiver module applying the sender model.

According to another aspect, a computer program may comprise instructions for causing an apparatus to perform at least the following: applying, by a receiver module, a sender model associated with a data source, the sender model being configured to predict the behavior of a sender module, the sender model being synchronized with a receiver model applied by the sender module, the receiver model being configured to predict the behavior of the receiver module at the sender module; generating, by the receiver module, an event based on the sender model applied by the receiver module; and causing, by the receiver module, transmission of the event.

According to another aspect, a computer program may comprise instructions for causing an apparatus to perform at least the following: creating, based on statistical data, a model for a data source; analyzing networking environment associated with the data source to set at least one key parameter associated with the data source; generating a sender module and a receiver module based on the model and the at least one key parameter; and causing transmission of the sender module and the receiver module.

According to an aspect, an apparatus may comprise means for applying, by a sender module, a receiver model associated with a data source, the receiver model being configured to predict the behavior of a receiver module, the receiver model being synchronized with a sender model applied by the receiver module, the sender model being configured to predict the behavior of the sender module; and means for omitting, by the sender module, based on the receiver model, messages associated with events that will be generated by the receiver module applying the sender model.

According to another aspect, an apparatus may comprise means for applying, by a receiver module, a sender model associated with a data source, the sender model being configured to predict the behavior of a sender module, the sender model being synchronized with a receiver model applied by the sender module, the receiver model being configured to predict the behavior of the receiver module at the sender module; means for generating, by the receiver module, an event based on the sender model applied by the receiver module; and means for causing, by the receiver module, transmission of the event.

According to another aspect, an apparatus may comprise means for creating, based on statistical data, a model for a data source; means for analyzing networking environment associated with the data source to set at least one key parameter associated with the data source; means for generating a sender module and a receiver module based on the model and the at least one key parameter; and means for causing transmission of the sender module and the receiver module.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a general structure of sender and receiver modules according to an example embodiment.

FIG. 2 illustrates an example of an apparatus configured to practice one or more example embodiments.

FIG. 3A illustrates an example of a flow chart for a sender module according to an example embodiment.

FIG. 3B illustrates an example of a flow chart for a receiver module according to an example embodiment.

FIG. 4 illustrates an example of a method for generating sender and receiver modules according to an example embodiment.

FIG. 5A illustrates an example of positioning the sender and receiver modules in a communication network according to an example embodiment.

FIG. 5B illustrates another example of positioning the sender and receiver modules in a communication network according to an example embodiment.

FIG. 5C illustrates another example of positioning the sender and receiver modules in a communication network according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

Some example embodiments of the present disclosure have been described in a specific data communication environment, for example, mobile communication network environment. The present disclosure can, however, be applied in any environment in which a sender node behaves in a manner that can be predicted. This leads to a situation in which the sender node does not have to send a message to a receiver node, but the receiver node may predict the behavior of the sender node, and act accordingly.

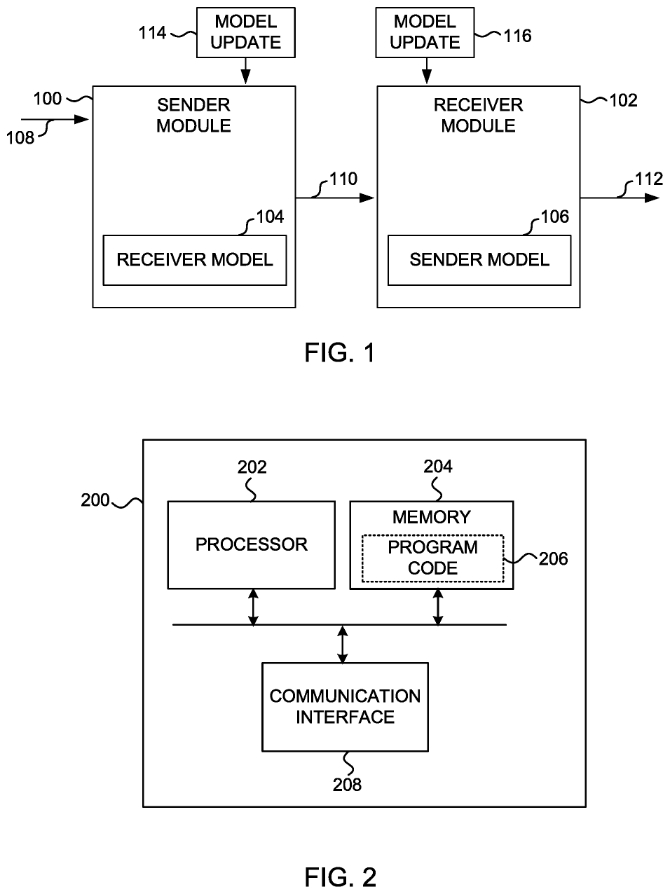

FIG. 1 illustrates an example of a general structure of a sender module 100 and a receiver module 102 according to an example embodiment.

The sender module 100 and the receiver module 102 may enable predictive communication through modelling the communicating entities, i.e., a sender and a receiver. This may significantly at least one of reduce latency and communication cost, and reduce the amount of data transmitted between the entities.

The sender module 100 may be associated with a data source that may provide events or triggers for the sender module 100. The sender module 100 may be implemented with the data source, for example, a sensor in a same entity or device, or the data source may be an entity external to the sender module 100. The sender module 100 comprises a receiver model 104 associated with the data source. The receiver model 104 is configured to predict the behavior of the receiver module 102. In other words, the receiver model 104 at the sender module 100 predicts what events or triggers the receiver module 102 expects to receive from the sender module 100. The receiver model 104 is synchronized with a sender model 106 applied by the receiver module 102. The sender module 100 is configured to omit, based on the receiver model 104, messages associated with events that will be generated by the receiver module 102 applying the sender model 106. This enables a solution, in which there is no need to send from the sender module 100 to the receiver module 102 messages that the receiver module 102 can correctly predict. Further, latency between the modules may be significantly decreased.

The receiver module 102 may be configured at any location from which the receiver module 102 may be communicatively connected to the sender module 100. The receiver module 102 is configured to apply the sender model 106 associated with the data source. The sender model 106 is configured to predict the behavior of the sender module 100. Further, the sender model 106 is synchronized with the receiver model 104 applied by the sender module 100. The receiver module 102 is configured to generate an event based on the sender model 106 applied by the receiver module 102 and cause transmission 112 of the event. This enables a solution, in which the receiver module 102 need not receive indications about events at the sender module 100 that can be predicted based on the sender model 106 at the receiver module 102.

The prediction applied by the sender module 100 and the receiver module 102 may enable a solution, in which communications latency and reaction time may be significantly reduced.

In an example embodiment, an event/message is sent 110 to the receiver module 102 only when it is not predicted at the receiver module 102 or that it is known that the prediction at the receiver module 102 will generate a false positive event/state update.

In an example embodiment, the receiver model 104 and the sender model 106 may receive model updates 114, 116 for the receiver model 104 and the sender model 106. The updates 114, 116 may be received from a remote entity via a communication link. Updates to the receiver model 104 and the sender model 106 may be required, for example, when the behavior of the data source changes, and thus the receiver model 104 and the sender model 106 should be updated accordingly.

In an example embodiment, the sender module 100 may store information associated with generating the receiver model 104, and the sender module 100 may receive parameter data associated with generating the receiver model 104. Based on the stored information and the parameter data, the sender module 100 may be configured to generate the receiver model 104. This may enable a solution, in which the sender module 100 has a built-in capability of generating the receiver model 104. This may enable, for example, a solution, in which receiver models may be generated and taken into use efficiently and quickly.

In an example embodiment, the receiver module 102 may store information associated with generating the sender model 106, and the receiver module 102 may receive parameter data associated with generating the sender model 106. Based on the stored information and the parameter data, the receiver module 102 may be configured to generate the sender model 106. This may enable a solution, in which the receiver module 102 has a built-in capability of generating the sender model 106. This may enable, for example, a solution, in which sender models may be generated and taken into use efficiently and quickly.

FIG. 2 illustrates an example embodiment of an apparatus 200, for example, a node implementing the sender module 100 or a node implementing the receiver module 102 illustrated in FIG. 1. The apparatus 200 may comprise at least one processor 202. The at least one processor 202 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The at least one memory 204 may be configured to store, for example, computer program code or the like, for example, operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable apparatus 200 to transmit and/or receive information to/from other devices. In one example, the apparatus 200 may use the communication interface 208 to transmit or receive signaling information and data in accordance with at least one data communication or cellular communication protocol. The communication interface 208 may be configured to provide at least one wireless radio connection, such as, for example, a 3GPP mobile broadband connection (e.g. 3G, 4G, 5G). In another example embodiment, the communication interface 208 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 200 is configured to implement some functionality, some component and/or components of the apparatus 200, for example, the at least one processor 202 and/or the at least one memory 204, may be configured to implement this functionality. Furthermore, when the at least one processor 202 is configured to implement some functionality, this functionality may be implemented using the program code 206 comprised, for example, in the at least one memory 204.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 200 may comprise means for performing at least one method described herein. In an example embodiment, the means may comprise the at least one processor 202, the at least one memory 204 including program code 206 configured to, when executed by the at least one processor, cause the apparatus 200 to perform the method.

The apparatus 200 may comprise, for example, a computing device, for example, a base station, a server, a mobile device, a mobile phone, a tablet computer, a laptop, an internet of things (IoT) device, or the like. Examples of IoT devices include, but are not limited to, consumer electronics, wearables, sensors, and smart home appliances. In one example, the apparatus 200 may comprise a vehicle such as, for example, a car. Although apparatus 200 is illustrated as a single device it is appreciated that, wherever applicable, functions of the apparatus 200 may be distributed to a plurality of devices, for example, to implement example embodiments as a cloud computing service.

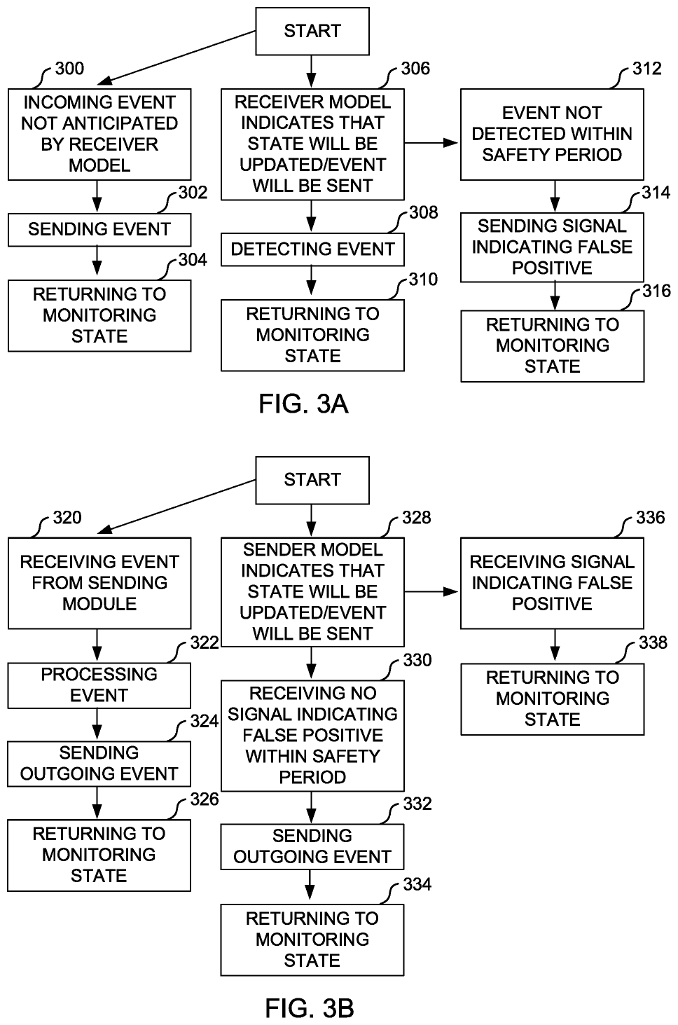

FIG. 3A illustrates an example of a flow chart for a sender module 100 according to an example embodiment. The sender module 100 has been discussed earlier in relation to FIG. 1.

At 300 the sender module 100 may receive an event or a trigger associated with a data source. The data source may be, for example, a sensor providing sensor data to the sender module 100, or another entity providing data from the sensor. The sender module 100 then determines that the received event or trigger is not predicted by the receiver model 104. This means that if no signal regarding the event is sent to the receiver module 102, the receiver module 102 will not be able to provide an appropriate action. Therefore, at 302 the sender module 100 sends an event or a message to the receiver module 102, and at 304 it returns to a monitoring state.

At 306 the receiver model 104 at the sender module 100 may indicate that a state will be updated/an event will be emitted. At 308, when the state is updated or the event is detected, the sender module 100 returns back to the monitoring state. This means that the event was predicted correctly and no other communication between the sender module 100 and the receiver module 102 is needed.

At 312, no event is detected by the sender module 100 within a safety period. This means that the sender module 100 fails to receive an event that was predicted. Thus, if the sender module 100 performs no further action towards the receiver module 102, the receiver module 102 will act based on its prediction, i.e., that an event happened as predicted. In order to prevent this, at 314 the sender module 100 sends a signal indicating a false positive prediction to the receiver module 102. After sending the signal, at 316 the sender module 100 returns to the monitoring state.

FIG. 3B illustrates an example of a flow chart for the receiver module 102 according to an example embodiment.

At 320 the receiver module 102 receives an event sent by the sending module 100 at 302. This event may be an event that is not predicted by the sender model 106 applied at the receiver module 102. At 322 the receiver module 322 processes the event. At 324 the receiver module sends an outgoing event, and at 326 returns to a monitoring state.

At 328 the sender model 106 applied by the receiver module 102 anticipates an incoming event or a state update. At 330, no false positive signal is detected or receiver from the sender module 100 within a safety period. This means that the anticipated or predicted event was correct, and at 332 an outgoing event is sent based on the prediction. At 334 the receiver module return to the monitoring state.

At 336 the receiver module 102 receives from the sender module 100 a signal indicating false positive. This signal may be sent from the sender module 100 at 314. When the signal indicating false positive is received from the sender module 100, it means that the sender module 100 intends to prevent the receiver module 102 to send an outgoing event. Thus, at 338 the receiver module returns to the monitoring state without sending the outgoing event.

As a summary of the above, the sender module 100 may predict when the receiver module 102 would send an event. Similarly, the receiver module 102 may generate events or state updates based on a prediction model of the model associated with the sender module 100. In an example embodiment, the sender module 100 transmits something (i.e., an event not predicted by the receiver module or a signal indicating false positive) to the receiving module 102 only when the sender module 100 realizes that the receiver module 102 is not able to provide a correct prediction result.

The mechanism discussed above in relation to FIGS. 3A and 3B may be suitable, for example, in the following situations:
a state update/an event from the sender module can be predicted
there is a cost in communications between the sender module and the receiver module
An event can be detected ahead of time
model synchronization cost is relatively low
precomputing state is feasible, for example, in AR/VR orientation, games etc.

Further, the sender module 100 and the receiver module 102 may be applied in any suitable communication environment, for example, relating to base station parameters, augmented reality (AR) sensor data, virtual reality (VR) sensor data, computer games requiring low latency, tactile internet, building automation systems, environmental parameters (for example, temperature), etc.

For example, when implementing the solution in a base station environment, base station raw counters and key performance indicators (KPI) may be modelled. The implementation would build on the learned counter and KPI distributions. Using the distributions, the sender module will omit certain events according to the desired Quality of Monitoring (QoM) accuracy. A counter may provide some measured value. For example, the counter may be associated with the number of transferred bits, number of network connections or number of active devices in a cell. For example, in counters associated with a base station, there may be thousands of counters for a single base station and a majority of the counters are zero-valued all the time. Thus, if these counter values were regularly sent over a communication connection, this would unnecessarily waste communication resources and increase latency.

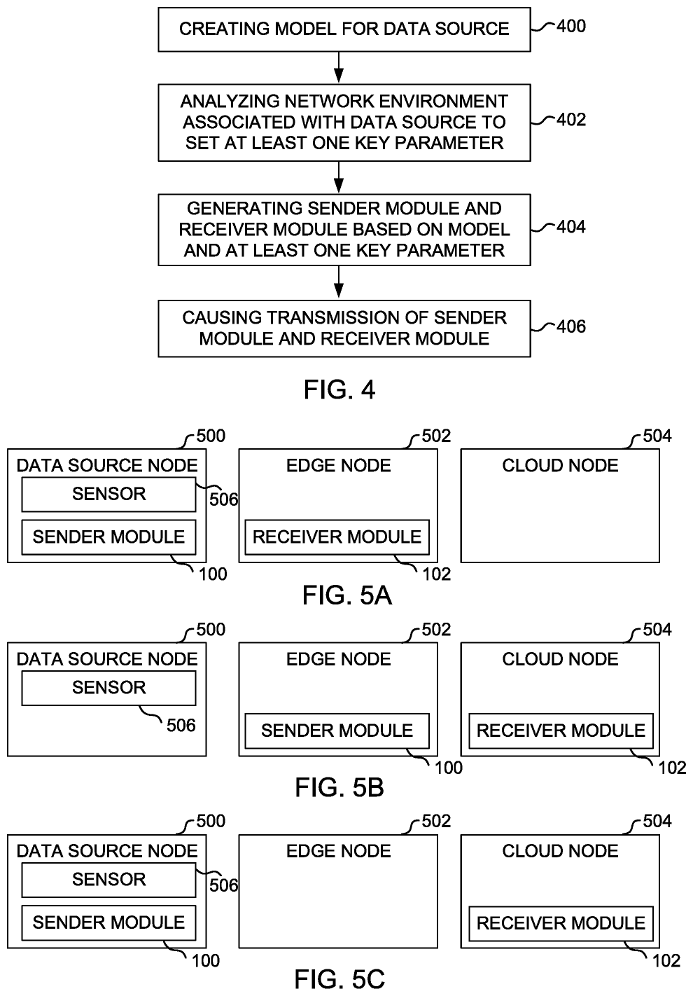

FIG. 4 illustrates an example of a method for generating the sender module 100 and the receiver module 102 according to an example embodiment.

In an example embodiment, a data source may be a source, the behavior of which can be modelled with a reasonable accuracy or very accurately. For example, the modelling may take into account “when”, i.e., when the data source provides an event, and “what”, i.e., the actual content of the event. If these two aspects can be modelled as accurately as possible, the prediction performed by the sender module 100 and the receiver module 102 will be accurate.

At 400 a model is created for the data source. This may involve at least one of analyzing offline data, considering external triggers, estimating detection probability and threshold etc. The model creation may, for example, analyze event patterns for feasibility and cost estimate.

At 402 network environment associated with the data source is analyzed to set at least one key parameter. The analysis may comprise analysis at different communication network locations, for example, at least one of device, edge and cloud. As an example, latency experienced at the locations may be very different, and latencies may be estimated separately for the locations. The at least one key parameter may comprise at least the following parameters:
an event safety period T
a time TC before actual detection (i.e., a detection prediction capability)
network latency TN

In an example embodiment, the predictive mechanism is applicable when T+TN<TC. A predictive capability (in other words, latency improvement) would then be TC−T−TN.

At 404 the sender module 100 and the receiver module 102 are generated based on the model and the at least one key parameter.

At 406 transmission of the sender module 100 and the receiver module 102 is caused to a sender system, for example, an IoT system and a receiver system, for example, a base station.

In an example embodiment, fine-tuning of the sender module 100 and the receiver module 102 may be performed in run-time. In other words, the sender module 100 and the receiver module 102 (or the sender model 106 and the receiver model 104) may be updated in run-time. In an example embodiment, it is possible to run the model updates using a distributed machine learning framework such as the Federated Learning.

By generating the sender module 100 comprising the receiver model 104 and the receiver module 102 comprising the sender model 106, latency may be minimized though placement of the modules.

In an example embodiment, another effect of deploying the sender and receiver modules may be that data communication across a network is reduced. Depending on the implementation, for example, the amount of transmitted base station KPIs, sensor readings etc. may be reduced significantly.

The solution illustrated in FIG. 4 may be implemented, for example, using an apparatus 200 discussed earlier relating to FIG. 2.

FIGS. 5A-5C illustrate examples of positioning the sender and receiver modules in a communication network according to some example embodiments.

FIG. 5A illustrates that the sender module 100 may be positioned at a data source node 500 together with a sensor 506 acting as the data source. The receiver module 102 may be positioned at an edge node 502. This positioning may be used for optimizing wireless communications if high wireless latency exists.

FIG. 5B illustrates that the sender module 100 may be positioned at the edge node 502 and the receiver module 102 may be positioned at a cloud node 504. This positioning may be used for optimizing edge-cloud communications if high cloud latency exists.

FIG. 5C illustrates that the sender module 100 may be positioned at the data source node 500 together with the sensor 506 acting as the data source. The receiver module 102 may be positioned at the cloud node 504. This positioning may be used for optimizing device-cloud communications if high end-to-end latency exists. Further, this positioning may be feasible if model synchronization is expected to happen very infrequently as model updates may have a higher cost in this positioning alternative.

In an example embodiment, the scenarios illustrated in FIGS. 5A-5C may be inversed. In other words, the sender module 100 may be positioned in the cloud node/edge node and the receiver module 102 may be positioned in the data source node/edge node.

An apparatus, for example, a node such as a user equipment, a mobile device, an IoT node, a network node or a cloud node may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code, the at least one memory and the computer code configured to, with the at least one processor, cause the apparatus at least to:
apply, by a sender module, a receiver model associated with a data source, the receiver model being configured to predict the behavior of a receiver module, the receiver model being synchronized with a sender model applied by the receiver module, the sender model being configured to predict the behavior of the sender module at the receiver module; and
omit, by the sender module, based on the receiver model, messages associated with events that will be generated by the receiver module applying the sender model.

2. The apparatus according to claim 1, wherein the at least one memory and the computer code are further configured to, with the at least one processor, cause the apparatus to:
determine, by the sender module, a first message to be sent to the receiver module, the message being associated with an event not predicted by the sender model applied by the receiver module; and
cause, by the sender module, transmission of the first message to the receiver module.

3. The apparatus according to claim 1, wherein the at least one memory and the computer code are further configured to, with the at least one processor, cause the apparatus to:
determine, by the sender module, a second message to be sent to the receiver module when the receiver module is expected to provide a false positive prediction based on the sender model applied by the receiver module; and
cause, by the sender module, transmission of the second message to the receiver module.

4. The apparatus according to claim 3, wherein the at least one memory and the computer code are further configured to, with the at least one processor, cause the apparatus to:
fail, by the sender module, to detect an event predicted by the receiver model applied by the sender module within a safety period; and
cause, by the sender module, transmission of the second message to the receiver module after expiry of the safety period.

5. The apparatus according to claim 1, wherein the at least one memory and the computer code are further configured to, with the at least one processor, cause the apparatus to:
detect, by the sender module, an event predicted by the receiver model applied by the sender module; and
return, by the sender module, to a monitoring state.

6. The apparatus according to claim 1, wherein the at least one memory and the computer code are further configured to, with the at least one processor, cause the apparatus to:
store, by the sender module, information associated with generating the receiver model;
receive, by the sender module, parameter data associated with generating the receiver model; and
generate, by the sender module, the receiver model based on the stored information and the parameter data.

7. The apparatus according to claim 1, wherein the at least one memory and the computer code are further configured to, with the at least one processor, cause the apparatus to:
receive the receiver model from an external entity.

8. An apparatus, comprising:
at least one processor; and
at least one memory including computer program code, the at least one memory and the computer code configured to, with the at least one processor, cause the apparatus at least to:
apply, by a receiver module, a sender model associated with a data source, the sender model being configured to predict the behavior of a sender module, the sender model being synchronized with a receiver model applied by the sender module, the receiver model being configured to predict the behavior of the receiver module at the sender module;
generate, by the receiver module, an event based on the sender model applied by the receiver module; and
cause, by the receiver module, transmission of the event.

9. The apparatus according to claim 8, wherein the at least one memory and the computer code are further configured to, with the at least one processor, cause the apparatus to:
receive, by the receiver module, a first message, the first message being associated with an event not predicted by the sender model applied by the receiver module; and
cause, by the receiver module, transmission of an event based on the first message.

10. The apparatus according to claim 8, wherein the at least one memory and the computer code are further configured to, with the at least one processor, cause the apparatus to:
receive, by the receiver module, a second message indicating that the sender model applied by the receiver module is expected to provide a false positive prediction; and
prevent, by the receiver module, transmission of an event based on the second message.

11. The apparatus according to claim 8, wherein the at least one memory and the computer code are further configured to, with the at least one processor, cause the apparatus to:
fail, by the receiver module, to receive within a safety period a second message indicating that the receiver is expected to provide a false positive prediction based on the sender model; and
cause, by the receiver module, transmission of the event.

12. The apparatus according to claim 8, wherein the at least one memory and the computer code are further configured to, with the at least one processor, cause the apparatus to:
store, by the receiver module, information associated with generating the sender model;
receive, by the receiver module, parameter data associated with generating the sender model; and
generate, by the receiver module, the sender model based on the stored information and the parameter data.

13. The apparatus according to claim 8, wherein the at least one memory and the computer code are further configured to, with the at least one processor, cause the apparatus to:
receive the sender module from an external entity.

14. An apparatus, comprising:
at least one processor; and
at least one memory including computer program code, the at least one memory and the computer code configured to, with the at least one processor, cause the apparatus at least to:
create, based on statistical data, a model for a data source;
analyze networking environment associated with the data source to set at least one key parameter associated with the data source;
generate a sender module and a receiver module based on the model and the at least one key parameter; and
cause transmission of the sender module and the receiver module.

15-20. (canceled)

21. A system comprising a first apparatus and a second apparatus,
wherein the first apparatus comprises:
at least one processor; and
at least one memory including computer program code, the at least one memory and the computer code configured to, with the at least one processor, cause the apparatus at least to:
apply, by a sender module, a receiver model associated with a data source, the receiver model being configured to predict the behavior of a receiver module, the receiver model being synchronized with a sender model applied by the receiver module, the sender model being configured to predict the behavior of the sender module at the receiver module; and
omit, by the sender module, based on the receiver model, messages associated with events that will be generated by the receiver module applying the sender model; and
wherein the second apparatus comprises:
at least one processor; and
at least one memory including computer program code, the at least one memory and the computer code configured to, with the at least one processor, cause the apparatus at least to:
apply, by a receiver module, a sender model associated with a data source, the sender model being configured to predict the behavior of a sender module, the sender model being synchronized with a receiver model applied by the sender module, the receiver model being configured to predict the behavior of the receiver module at the sender module;
generate, by the receiver module, an event based on the sender model applied by the receiver module; and
cause, by the receiver module, transmission of the event.
